(19) United States
(12) Patent Application Publication
(10) Pub. No.: US 2013/0005401 A1
(43) Pub. Date: Jan. 3, 2013

(54) ERGONOMIC HANDLE FOR SMARTPHONE VIDEO RECORDING

(75) Inventors: Branden D. Rosenhan, Salt Lake City, UT (US); Taylor Bench, Salt Lake City, UT (US); Luke T. Behrmann, Salt Lake City, UT (US)

(73) Assignee: The University of Utah, Salt Lake City, UT (US)

(21) Appl. No.: 13/540,273

(22) Filed: Jul. 2, 2012

Related U.S. Application Data
(60) Provisional application No. 61/504,069, filed on Jul. 1, 2011.

(51) Int. Cl. H04M 1/00; H04B 1/38

(52) U.S. Cl. 455/557

(57) ABSTRACT

The present invention provides an ergonomically designed smartphone handle mount device that attaches and secures itself to a smartphone to facilitate operation of video recording. The device includes a grippable handle portion, mount structure for securing a smartphone, controls for controlling recording and/or zooming, and an electronic connection interface for providing electronic communication between the controls of the handle mount device and the smartphone. The device provides a quick and convenient way to take advantage of the increasingly high resolution capabilities of smartphones and may completely eliminate the need for other camcorder devices for many users. The recording, zooming, or other buttons or controls may be within easy reach of the user's fingers when gripping the handle portion of the device.

### CROSS REFERENCE TO RELATED APPLICATIONS

This application claims the benefit of U.S. Provisional Patent Application No. 61/504,069, filed Jul. 1, 2011 entitled ERGONOMIC HANDLE FOR SMARTPHONE VIDEO RECORDING, the disclosure of which is incorporated herein in its entirety.

### BACKGROUND OF THE INVENTION

1. The Field of the Invention

The present invention is in the field of accessories for use with smartphones equipped with video capability.

2. The Relevant Technology

New to the market in the past few years are so called smartphones (e.g., iPhone, Android based, etc.). They include, among other capabilities, excellent HD video capability. Although such devices include video capability that can rival that of a traditional handheld camcorder, rarely are such devices used when a person seeks to capture good video at sporting or other events (e.g., a child's soccer game or other performance). One reason for this is because it is awkward to hold the device for an extended period of time. In addition, it can be difficult to use the touch screen controls while attempting to capture video images, especially while moving, or in bright sunlight, which obscures the ability to see the touchscreen controls.

### BRIEF SUMMARY

The present invention is directed to an ergonomically designed smartphone handle mount device that attaches and secures itself to a smartphone. The ergonomic handle mount provides a quick and easy way to take advantage of the high resolution capabilities of the built-in video capabilities of a smartphone. It may completely eliminate the need for other camcorder devices. According to one embodiment, the ergonomic handle mount device includes a grippable handle portion, a mount structure for mounting a smartphone to the ergonomic handle device, controls disposed on the handle mount device (e.g., on the grippable handle portion) for controlling at least one of recording or zooming, and an electronic connection interface for providing electronic communication between the controls of the handle mount device and the smartphone.

According to another embodiment, the ergonomic handle mount device includes a grippable handle portion, mount structure for mounting a smartphone to the ergonomic handle mount device, controls disposed on the handle mount device (e.g., on the grippable handle portion) for controlling both recording and zooming, an electronic connection interface for providing electronic communication between the controls of the handle mount device and the smartphone, and at least one auxiliary lens attachable to the handle mount device that is configured to adjust an aperture of a lens already included within the smartphone as part of the smartphone's video capability.

According to yet another embodiment, the ergonomic handle mount device includes a grippable handle portion, a mount structure for directly or indirectly mounting a smartphone to the ergonomic handle device, controls disposed on the handle mount device (e.g., on the grippable handle portion) for controlling at least one of recording or zooming, and an electronic connection interface for providing electronic communication between the controls of the handle mount device and the smartphone. For example, the mount structure may mount directly to the smartphone itself, or may mount to a protective case that nestingly receives at least a portion of the smartphone.

These and other benefits, advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A shows use of a smartphone with video capability;

FIG. 1B shows an exemplary screen side view of an ergonomic handle mount device to which the smartphone of FIG. 1A is mounted;

FIG. 2A is a lens side view of the ergonomic handle mount device and smartphone of FIG. 1B;

FIG. 2B is a side edge view showing the smartphone mounted within the ergonomic handle mount device of FIG. 1B;

FIGS. 3A-3B are lens side and side edge views, respectively, showing an embodiment of an ergonomic handle mount device in which the mounting structure that facilitates mounting of the smartphone to the handle mount device can be collapsed within the grippable handle portion of the handle mount device;

FIG. 3C shows the ergonomic handle mount device of FIGS. 3A-3B in which the mounting structure is being further collapsed into the grippable handle portion;

FIGS. 4A-4B illustrate another embodiment of an ergonomic handle mount device to which a smartphone can be mounted;

FIGS. 5A-5B show an alternative embodiment of a handle mount device configured as a protective case into which a smartphone nests; and

FIGS. 6A-6B show an alternative embodiment of an ergonomic handle mount device in which the handle mount device mounts to a protective case into which the smartphone nests.

### DETAILED DESCRIPTION OF THE PREFERRED EMBODIMENTS

### I. Introduction

The present invention is directed to an ergonomically designed smartphone handle mount device adapted to be attached and secure directly or indirectly to a smartphone. Indirect mounting may occur, for example, where the smartphone is nested within a protective case, and the handle mount device mounts to the protective case. The inventive embodiments provide a quick and easy way to better take advantage of the increasingly high resolution capabilities of current smartphones for video and still photography. Many such smartphones are capable of 480p, 720p, or even higher resolution (e.g., 1080p) video.

### II. Exemplary Ergonomic Handle Mount Devices

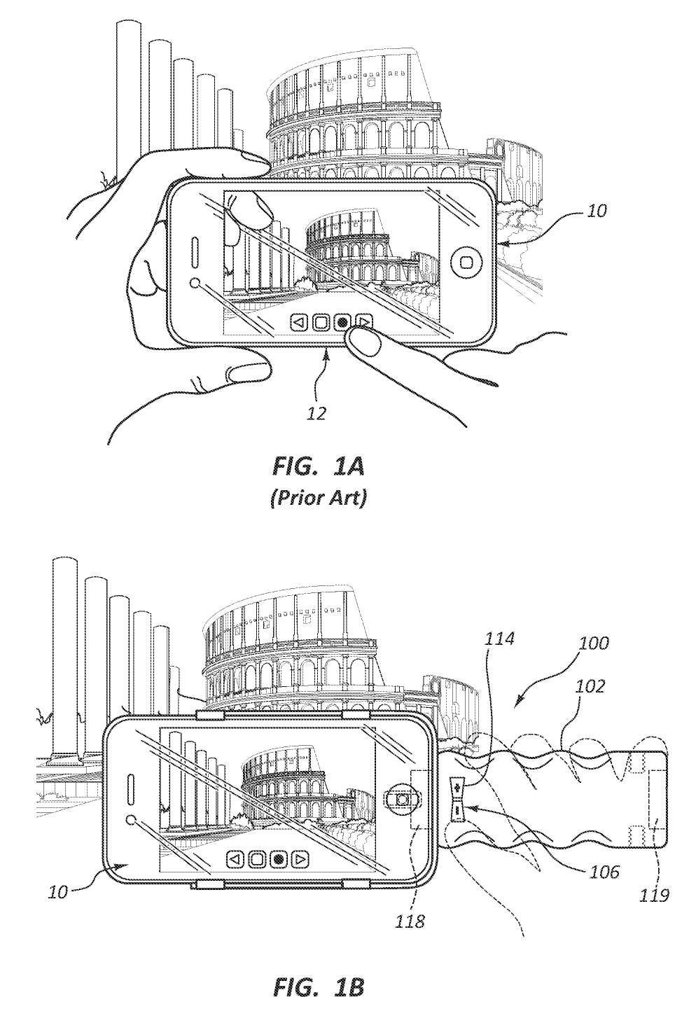

FIG. 1A shows a typical smartphone 10 (e.g., an iPhone, Android, etc. based smartphone) that does not include any handle or other structure to comfortably hold the smartphone and which requires the use of both hands to control the video camera by a touch pad or button(s) 12 of the phone itself, making video capture potentially awkward, inconvenient, and unsteady.

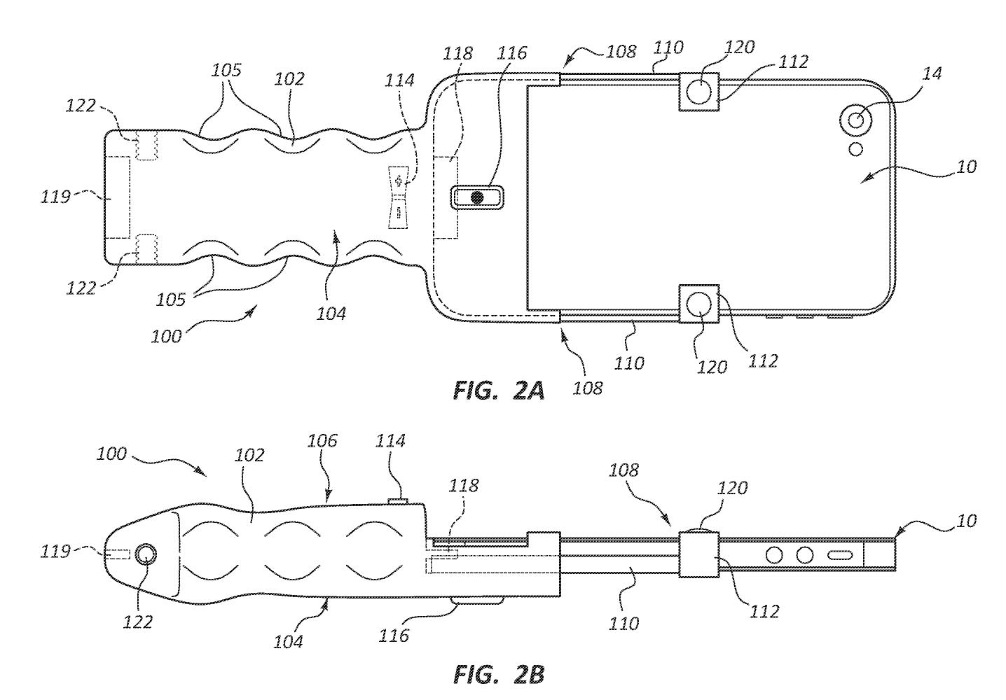

FIG. 1B shows use of an exemplary ergonomic handle mount device 100 that includes an ergonomic grippable handle portion 102 at a proximal end of device 100 that may be easily gripped by the user. For example, grippable handle portion 102 may have an elongate rounded configuration to allow a user's fingers to wrap around portion 102 so that the user's fingertips may rest adjacent one face 104 (FIG. 2A) of handle portion 102, while the user's thumb may rest adjacent an opposite face 106 of handle portion 102. As seen in FIGS. 1B and 2A, with a single hand, the user can conveniently and easily operate both record button 116 (FIG. 2A) with wrapped around fingers, while simultaneously allowing operation of zoom button 114 with the thumb. (FIG. 1B)

Grippable handle portion 102 of device 100 may include an undulating surface 105 with finger recesses, particularly between faces 104 and 106, to better accommodate the user's fingers as they wrap around grippable handle portion 102. Handle mount device 100 may be formed of any suitable material (e.g., metal, plastic, etc.). The exterior gripping surface intended to be contacted by the user's gripping fingers and/or palm may include a relatively soft low durometer elastomeric rubber-like material (e.g., a thermoplastic elastomer, silicone, etc.). Other portions of the device may be formed of a more rigid material (e.g., rigid plastic or metal) to provide strength and durability.

Device 100 further includes mounting structure 108 (e.g., having arms 110 and clips 112) for securely mounting a smartphone (e.g., such as smartphone 10 seen in FIG. 1A) to device 100 so that the user may simply grip ergonomic handle portion 102, while smartphone 10 is securely mounted by arms 110 and clips 112, or other mount structure that secures smartphone 10 to mount device 100. This helps prevent accidental dropping and associated damage to smartphone 10, as a more secure, less awkward grip or hold on smartphone 10 is provided using device 100 as compared to conventional use as in FIG. 1A. Furthermore, handle mount device 100 advantageously allows easy single handed operation of recording and/or zooming functions through device 10, which communicates with those video capability functions available within smartphone 10.

Mounting structure 108 may comprise a pair of oppositely disposed arms 110 as seen in FIG. 2A, each of which extends along at least a portion of the length of the sides of smartphone 10. In the embodiment illustrated by FIG. 2A, handle mount device 100 may also mount to and extend along a bottom end of smartphone 10. At an end of arm 110 may be disposed a clip 112 or other mount structure configured to securely mount directly to smartphone 10 or to a protective case of smartphone 10 so as to hold it in place. Thus the user does not need to directly hold smartphone 10, but simply grasp proximal handle portion 102 of the device to support the smartphone 10 during video recording.

As seen in FIGS. 1B and 2A-2B, an elongate toggle button 114 for zooming in/out may be included on one face (e.g., face 106) of ergonomic handle portion 102, while a record button 116 may be disposed on an opposite face (e.g., face 104) of ergonomic handle portion 102. Of course, the position of the buttons can be reversed or placed elsewhere on handle mount device 100. That said, the illustrated positioning of controls 114 and 116 may be particularly advantageous as it allows convenient control within a single gripping hand as the finger tips (e.g., the index finger) can depress record button 116, and the thumb can easily manipulate either side of toggle zoom control 114. This can be done by sight or touch, which greatly enhances control of the smartphone video camera as compared to using the touch screen, especially in bright light.

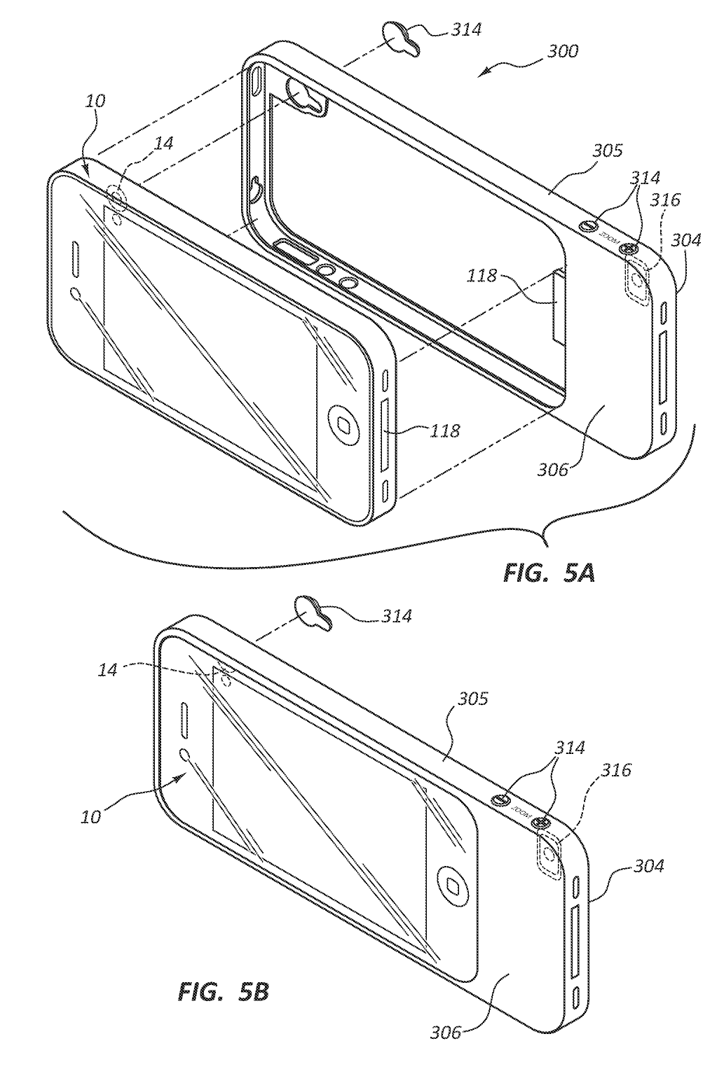

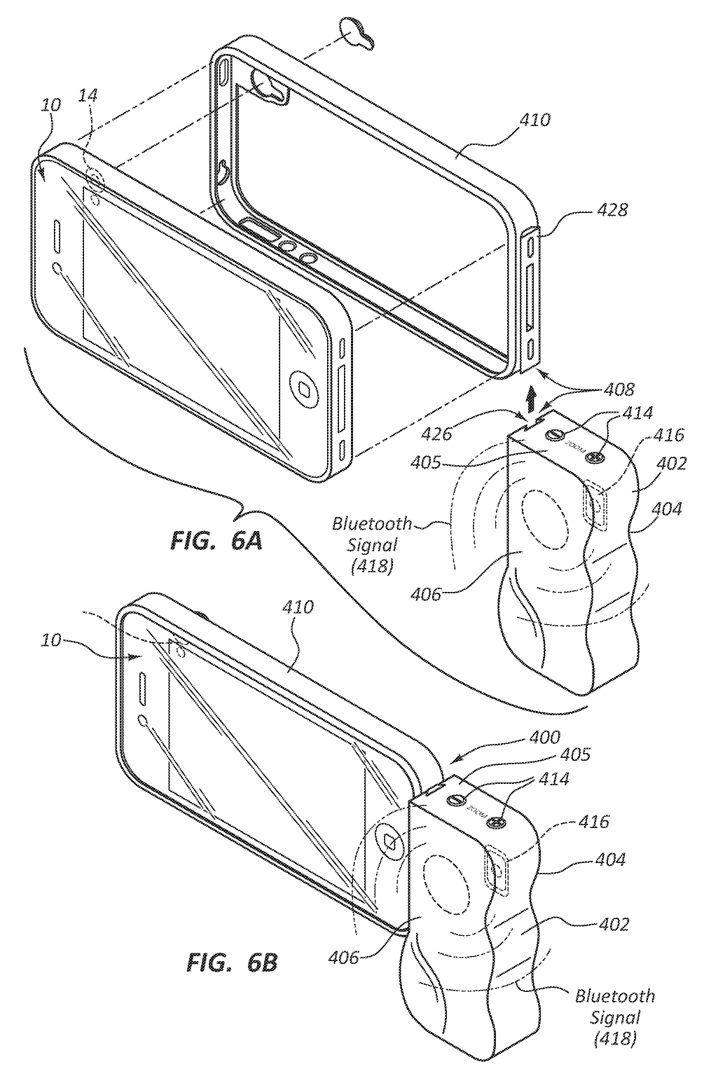

Toggle zoom control 114 may comprise a toggle type control button that is elongate, and provides zooming in when one end of elongate button 114 is depressed (e.g., when depressing the “+”) and provides zooming out when an opposite end of the elongate button 114 is depressed (e.g., when depressing the “−”). Other zoom controls may alternatively be employed. For example, FIGS. 5A-5B and 6A-6B show use of two separate zoom buttons (a “+” labeled button for zooming in and a “−” labeled button for zooming out).

In addition to zooming and/or recording controls, device 100 may include various other video controls including, but not limited to, focusing, color balance, mode options (e.g., video vs. still photo), flash or other lighting controls, flip function, or other functions available through the video capabilities of smartphone 10. Such other buttons or controls may also be within easy reach of the user's fingers when gripping the handle portion 102 of device 100.

As seen in FIGS. 1B and 2A-2B, handle mount device 100 may include an electronic connection interface 118 that may sync or otherwise communicate with smartphone 10 so as to allow operation and control of the zoom and record features (and/or other features) available through the camera function of smartphone 10 through the control buttons 114, 116 disposed on handle mount device 100. This allows operation of these features without having to control record, zoom, or other features through the touchscreen or other controls 12 of the smartphone itself. In the case of a hard-wired physical connection, the corresponding electronic connection interface (e.g., USB port or other data port) of smartphone 10 to which interface 118 connects may typically be disposed in a bottom end of smartphone 10. In an alternative embodiment, electronic connection interface 118 may comprise a wireless connection (e.g., through Bluetooth, IR, etc.), so that no physical electronic connection is required.

In one embodiment, device 100 may further comprise an interface (e.g., a wireless connection or physical wired connection) or other means for interfacing the device with a computer system other than the computer components of the smartphone. For example, one may wish to transfer videos or still photos to a laptop, desktop, tablet PC, etc.). This can be accomplished, for example, using a data port (e.g., through a high speed wireless network connection).

In one embodiment of a physical wired connection, electronic connection interface 118 may include a soft rubber like attachment or base to avoid breakage of pins as a result of torquing of smartphone 10 relative to handle portion 102. The use of a soft material (e.g., a thermoplastic elastomer or other elastomeric materials such as silicone) surrounding port 118 can provide a significant amount of “give” to the design to prevent breakage.

Device 100 (e.g., within handle portion 102) may include a built-in charger (e.g., an auxiliary battery) 119 that allows charging of smartphone 10 when secured to handle mount device 100. In one embodiment, built-in charger 119 may include a hard wired power connection that connects to a power outlet, so that the user may plug handle 102 into a standard wall outlet or other wired power source (e.g., charging through a USB connection) to charge the auxiliary battery. Where interface 118 is a wired physical connection, direct pass-through charging of smartphone 10 from built-in charger 119 may also be provided through port 118.

In another embodiment, device 100 (e.g., within handle portion 102) may provide for auxiliary memory (e.g., a port for accepting any of various memory cards (e.g., SD, xD, Mini SD, CompactFlash, etc.) so that video or still photos may be saved to such a memory card. This greatly facilitates transfer of recorded data from smartphone to computer or other device, such as a player.

FIGS. 2A-2B illustrate a lens side view and side edge view, respectively, of handle mount device 100 mounted to smartphone 10. In the embodiment shown in FIG. 2A, the face of the smartphone including camera lens 14 is oriented in the same direction as the record button or trigger 116 on face 104 of handle mount device 100. In typical operation, the user may grasp handle portion 102 and orient smartphone 10 so that the user is viewing the touchscreen face of smartphone 10 (e.g., as seen in FIG. 1B). The zoom toggle button 114 is disposed on face 106 of handle portion 102 so as to be oriented with the touchscreen of smartphone 10 (i.e., towards the user) for easier viewing. As shown in FIG. 1B, the user may thus use the thumb of the gripping hand to manually adjust zoom toggle button 114, while the fingers (e.g., index finger) of the same hand (which wrap around the grippable handle portion 102) may be used to manually hit the record trigger or button 116. This permits the user to see the video image while zooming in or out and/or initiating/pausing recording.

Handle mount device 100 may further include a light 120 (e.g., for video) or flash 120 (e.g., for still photos) for providing additional light when recording in relatively dark environments. In one embodiment, the device may further include a light sensor for automatically selecting whether to activate the light or flash when recording video or a still photo. Controls for setting the light or flash mode may be disposed on handle portion 102 or elsewhere on device 100. Control of such functions may also be provided directly through smartphone 10 (e.g., through the touchscreen). For example, the smartphone may have software instructions (e.g., an app) loaded thereon that allows control of the light or flash 120 of the handle mount device 100 through the touchscreen or other input of smartphone 10. The smartphone itself includes a processor, memory, and storage similar to that found in typical computer devices in order to run such installed applications.

As seen in FIGS. 2A-2B, handle device 100 (e.g., within handle portion 102) may include one or more tripod mount structures 122 (e.g., ¼-20 UNC threads as standardized by ISO 1222:2010) to allow easy mounting of handle mount device 100 (and smartphone 10) to a tripod. The embodiment of FIG. 2A shows two threaded cavities 122 on opposite sides of handle portion 102, between faces 104 and 106. This allows mounting of device 100 and smartphone 10 to a tripod in either orientation. An app may also be loaded on the smartphone to facilitate communication and control between the handle mount device and video and photo functions of the smartphone.

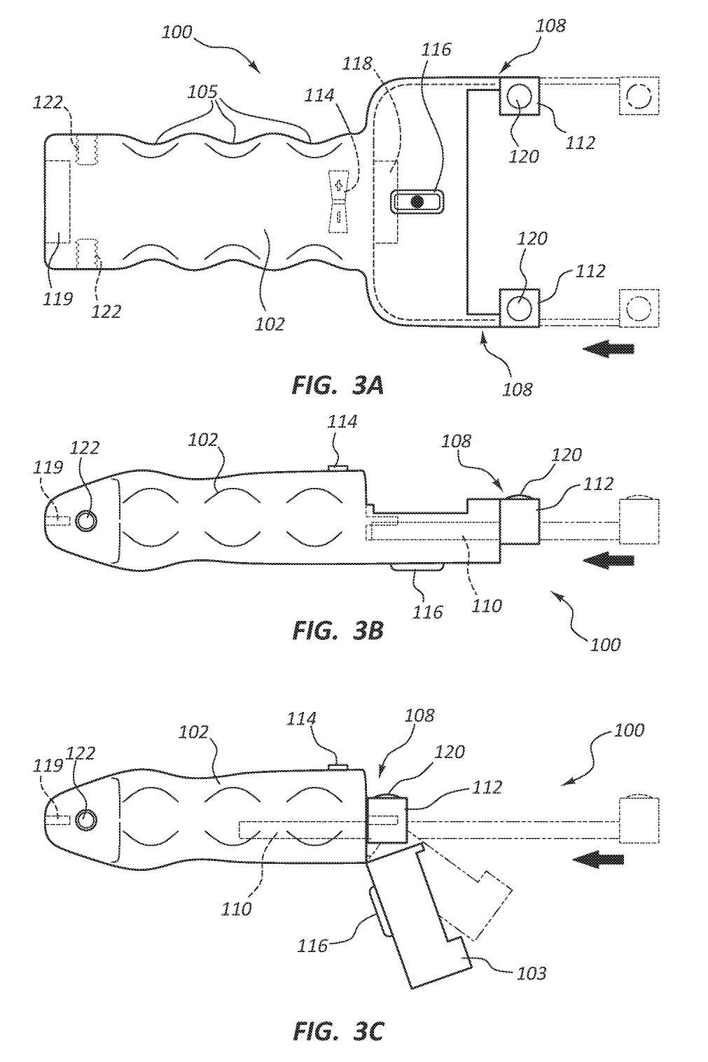

FIGS. 3A-3C show one lens side view and two side edge views, respectively, of a collapsible handle mount device 100 configuration such as that shown in FIG. 2A and in which the mounting structure 108 may be collapsed for storage into the ergonomic handle portion 102 of the device so as to provide a compact storage configuration when not in use (e.g., as seen in FIG. 3C). Such a compact device 100 could be easily stored within a purse or pocket (e.g., where a smartphone may also be stored).

As seen in FIGS. 3B-3C, a top cover portion 103 of grippable handle 102 may be hinged or otherwise connected so that it can flip or otherwise open so as to receive collapsed mounting structure 108 therein, as best seen in FIG. 3C. When it is desired to deploy mounting structure 108 for use, the folded down or collapsed mount structure 108 stored within a cavity of hollow handle 102 can be unfolded or otherwise extended by reverse action. In the unfolded configuration, mounting structure 108 at the distal end of device 100 can assume the position shown in FIGS. 2A-2B so as to couple with or otherwise secure smartphone 10 in place relative to handle mount device 100. Various collapsible mechanisms by which the arms 110 or other mount structure may fold or otherwise collapse into handle portion 102 of device 100 will be apparent to one of skill in the art. For example, each arm 110 may include one or more hinges or other bendable connection mechanisms.

Other components of the device (e.g., an extension arm including a light or flash 120) may similarly be collapsible within handle portion 102. The collapsing mechanisms may be of any suitable configuration. For example, a flash or light 120 may include a telescoping extension member that can be pulled so as to telescopingly extend from handle portion 102 of device 100 when use of a flash 120 or light 120 is desired. Arms 110 could also include telescoping members to facilitate their collapse into handle portion 102.

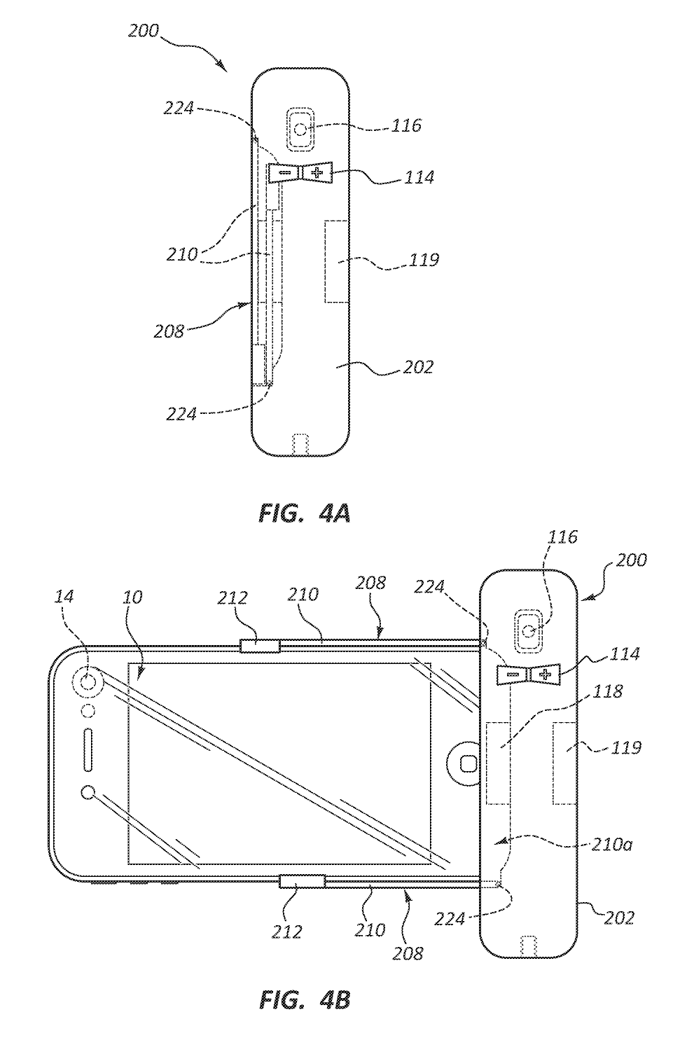

FIGS. 4A-4B illustrate another configuration of an ergonomic handle mount device 200 in which mounting structure 208 of handle mount device 100 similarly secures device 200 to smartphone 10, but in which the longitudinal axis of handle portion 202 is transverse to the longitudinal axis of extended mounting arms 210. In the previously illustrated embodiments, the longitudinal axis of handle portion 102 and the longitudinal axis of the mounting arms 110 (when extended and secured to smartphone 10) are generally parallel to one another. The alternative configuration shown in FIGS. 4A-4B in which the axes are generally perpendicular to one another may more easily provide a landscape orientation to the camera of the smartphone rather than the alternative configuration which is rotated 90° relative to that shown in FIGS. 4A-4B. In other words, FIGS. 4A-4B show what may be referred to as a side-mount configuration rather than the bottom-mount configuration shown in FIG. 2A.

As seen in FIGS. 4A-4B, mounting arms 210 may assume a compact folded down configuration as seen in FIG. 4A when not in use and not secured to smartphone 10. It will be appreciated that in one embodiment, mounting arms 210 may collapse to be received within handle portion 210a, as shown in FIG. 4A. In another embodiment, mounting arms 210 may not necessarily be received internally within handle portion 202 of device 200, but simply fold down adjacent the exterior surface of handle portion 202. In such a configuration, it may not be necessary for the handle portion to include a hollow cavity 210a for receiving mounting structure 210. Each arm 210 may be hinged at a proximal end near the point of attachment 224 to handle portion 202 of device 200, as perhaps best seen in FIG. 4B. In another embodiment, mounting arms 210 may also have telescoping capability to allow them to extend or lengthen if needed for more secure attachment to the smartphone while contracting or shortening when not in use, so as to allow more convenient and compact storage in a pocket or purse.

FIGS. 5A-5B show another embodiment of a handle mount device 300 configured as a protective case into which smartphone 10 nests. Protective case includes zoom controls 314 shown on a side surface 305 of device 300, between faces 304 and 306, while record control button 316 is disposed on another surface (e.g., face 304). The user may grip faces 304 and 306, while controls 314 and 316 are positioned to allow a user to manipulate zoom controls 314 with a thumb while reaching record control 316 with an index or other finger. Electronic connection interface 118 provides an electronic connection interface for providing electronic communication between controls 314 and 316 on device 300 and smartphone 10.

In one embodiment, one or more auxiliary lenses 314 may be provided. Such lenses may be selectively attached to device 300 so as to be aligned with camera lens 14 of smartphone 10 in order to adjust the aperture provided by lens 14. For example, various such interchangeable auxiliary lenses may be provided to allow the user to select an appropriate lens based on filming conditions and a desired video shot.

FIGS. 6A-6B show another embodiment of a handle mount device 400 that is similar to that shown in FIGS. 4A-4B in that ergonomic handle 402 provides a side-mount configuration relative to smartphone 10. Handle mount device 400 includes an ergonomic grippable handle portion 402. Mounting structure 408 provides a sliding connection to corresponding structure disposed on a protective smartphone case 410. Protective case 410 is configured to receive smartphone 10 in a nesting configuration. Protective case 410 may provide some level of protection to smartphone 10 against damage due to dropping, water (e.g., rain, snow, spills), or other environmental factors.

In the illustrated configuration, mounting structure 408 includes a slot 426 and a corresponding rail 428 in case 410 configured to be slidably received within slot 426. While slot 426 is shown as being disposed adjacent handle portion 402 and rail 428 is disposed on a side of protective case 410, it will be understood that these locations may be reversed. In addition, other connection mechanisms may alternately be employed. For example, the corresponding mounting structures may slide, latch, or otherwise lock into place relative to one another.

Ergonomic handle portion 402 includes zoom controls 414 shown on a side surface 405, between faces 404 and 406, while record control button 416 is disposed on another surface (e.g., face 404, to be on the same side as camera lens 14). Of course, the toggle type focus control button 114 of FIGS. 1B and 2A may alternatively be employed with any of the embodiments. Electronic connection interface 418 is shown as being a wireless Bluetooth connection. Wireless connection 418 provides an electronic connection interface for providing electronic communication between controls 414 and 416 on device 400 and smartphone 10.

While FIG. 5A shows ergonomic handle portion 402 being separate from protective case 410, it will be understood that in an alternative embodiment, ergonomic handle 402 may be fixedly attached to protective case 410. Protective case 410, which may be separate from or fixedly attached to and integral with elongate handle 402, may be soft, flexible, and water-resistant (e.g., waterproof). Such a flexible protective case 410 may be rolled up around grippable handle portion 402 for ease of storage. In another embodiment, protective case 410 may be rigid and water-resistant (e.g., waterproof).

A configuration as shown in FIGS. 6A-6B may also advantageously allow for interchangeability of handle 402 so that handle 402 may be used with various smartphones. For example, variously configured protective cases such as that shown at 410 may be provided for various different smartphones (e.g., iPhones, Androids, etc.). Each protective case that is specifically configured to nestingly receive the corresponding smartphone can also include a portion of a universal adapter (e.g., such as that shown by rail 428 and slot 426) so that one may disconnect handle portion 402 from one protective case and mount it to another protective case. Thus, if a user replaces their existing smartphone with another, they may continue to use their already acquired handle 402 with a new phone by simply purchasing the needed protective case for that particular smartphone.

Where protective case 410 is soft and flexible, it may be possible that a single case configuration may be compatible with various smartphone shapes and sizes. Where protective case 410 is hard and rigid, case 410 may be specifically configured for an individual smartphone model.

It will be apparent that while the term “smartphone” is employed herein for purposes of simplicity, it will be understood that the described embodiments can be used with devices that do not necessarily include phone capability. As such, the term “smartphone” is to be construed broadly to include devices incorporating camera capabilities, particularly video capability, even if such devices may not have phone capability (e.g., an iPod touch or miniature Android tablet device).

As will be apparent to one of skill in the art, the handle mount device may include a computer system having one or more processors and computer readable media such as computer memory. In particular, the computer memory may store computer executable instructions that when executed by one or more processors cause various functions to be performed, such as the acts recited in the embodiments (e.g., control of zooming, recording, focus adjustment, color control, etc.). The handle may include a wireless transmitter to communicate with a networked computer, or a part for a wireless transmitter.

Computer executable instructions (e.g., software) provided within the ergonomic handle mount device may include instructions for controlling any functions available through the video and camera capability of the smartphone. Examples of such software features may include, but are not limited to zoom control, recording control, focus adjustment, color balance controls, a timer function, delete function (e.g., delete an unwanted photo or video), crop function, redeye reduction, flash controls, lighting controls, playback controls, and capability for uploading photos or videos to an album or to the web (e.g., youtube, facebook, shutterfly, etc.). Various buttons or other controls may advantageously be provided on the handle mount device (e.g., on the handle portion) to control such features. This advantageously allows control of features available through the photo and video capabilities of the smartphone without requiring use of the normal controls in the smartphone (e.g., touchscreen controls 12).

Embodiments of the present invention may comprise or employ smartphone computer components including computer hardware, as discussed in greater detail below. Embodiments within the scope of the present invention also include computer-readable media for carrying or storing computer-executable instructions and/or data structures. Such computer-readable media can be any available media that can be accessed by the smartphone computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, other magnetic storage devices, or any other medium which can be used to store desired program code means in the form of computer-executable instructions or data structures and which can be accessed by the smartphone computer system.

A “network” is defined as one or more data links that enable the transport of electronic data between computer systems and/or modules and/or other electronic devices. For example, data may be transmitted between the handle portion including the external recording and zooming controls and the smartphone. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by the smartphone computer system.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device such as a smartphone to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the invention. An “app” loaded on the smartphone is an exemple of computer-executable instructions.

As used in this specification and the appended claims, the singular forms “a,” “an” and “the” include plural referents unless the context clearly dictates otherwise.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An ergonomic handle mount device for attachment to a smartphone device with video capability, the device comprising:
a grippable handle portion;
a mount structure for mounting a smartphone to the ergonomic handle mount device;
controls disposed on the handle mount device for controlling at least one of recording or zooming; and
an electronic connection interface for providing electronic communication between the controls of the handle mount device and the smartphone.

2. An ergonomic handle mount device as recited in claim 1, wherein the device includes both recording and zooming controls.

3. An ergonomic handle mount device as recited in claim 2, wherein the recording control and the zooming control are disposed on opposite faces of the grippable handle portion of the device so that one can be easily manipulated by a user's thumb and the other can be easily manipulated by a user's finger during use.

4. An ergonomic handle mount device as recited in claim 2, wherein the zooming control comprises a toggle button.

5. An ergonomic handle mount device as recited in claim 1, wherein the electronic connection interface comprises a physical wired connection.

6. An ergonomic handle mount device as recited in claim 1, wherein the electronic connection interface comprises a wireless connection.

7. An ergonomic handle mount device as recited in claim 1, further comprising a built-in charger configured for charging a smartphone attached to the device.

8. An ergonomic handle mount device as recited in claim 1, further comprising a processor and system memory.

9. An ergonomic handle mount device as recited in claim 8, further comprising storage media for storing thereon executable instructions for controlling video capabilities of a smartphone attached to the device.

10. An ergonomic handle mount device as recited in claim 1, further

11. An ergonomic handle mount device as recited in claim 1, further comprising controls for controlling one or more of focusing, color balance, mode options, flash or other lighting controls, a flip function, or other functions available through the video capabilities of a smartphone.

12. An ergonomic handle mount device as recited in claim 1, wherein the mount structure is configured to mount the handle mount device to a protective case to which a smartphone is mechanically connected.

13. An ergonomic handle mount device as recited in claim 1, further comprising a tripod mount structure for mounting the handle mount device to a tripod.

14. An ergonomic handle mount device as recited in claim 1, further comprising at least one auxiliary lens configured to adjust an aperture of a lens included with a smartphone with video capability.

15. An ergonomic handle mount device as recited in claim 14, wherein the at least one auxiliary lens comprises a plurality of interchangeable auxiliary lenses.

16. An ergonomic handle mount device for attachment to a smartphone device with video capability, the device comprising:
a grippable handle portion;
a mount structure for mounting a smartphone to the ergonomic handle mount device;
controls disposed on the handle mount device for controlling recording and zooming;
an electronic connection interface for providing electronic communication between the controls of the handle mount device and the smartphone; and
at least one auxiliary lens attachable to the handle mount device, the at least one auxiliary lens being configured to adjust an aperture of a lens included with the smartphone.

17. An ergonomic handle mount device for attachment to a smartphone device with video capability, the device comprising:
a grippable handle portion;
a mount structure for directly or indirectly mounting a smartphone to the ergonomic handle mount device;
controls disposed on the handle mount device for controlling at least one of recording or zooming; and
an electronic connection interface for providing electronic communication between the controls of the handle mount device and the smartphone.

18. An ergonomic handle mount device as recited in claim 17, wherein the mount structure comprises a soft, flexible, water-resistant protective case that nestingly receives a smartphone, so that the soft flexible case can be rolled up around the grippable handle for ease of storage.

19. An ergonomic handle mount device as recited in claim 18, wherein the grippable handle is fixedly attached to the soft, flexible, water-resistant protective case so as to not be removable therefrom.

20. An ergonomic handle mount device as recited in claim 17, wherein the mount structure comprises a rigid and water-resistant protective case that nestingly receives a smartphone, the grippable handle and rigid protective case comprising locking structure for attaching to one another.
